(19) United States
(12) Patent Application Publication
(10) Pub. No.: US 2025/0356869 A1
(43) Pub. Date: Nov. 20, 2025

(54) METHOD AND APPARATUS FOR TIMBRE CONVERSION, ELECTRONIC DEVICE, AND PRODUCT

(71) Applicants: Beijing Zitiao Network Technology Co., Ltd., Beijing (CN); Lemon Inc., Grand Cayman (KY)

(72) Inventors: Dongya Jia, Beijing (CN); Jian Cong, Beijing (CN); Zhuo Chen, Los Angeles, CA (US); Yuanzhe Chen, Beijing (CN); Zhengxi Liu, Beijing (CN); Jiawei Chen, Beijing (CN); Yuping Wang, Beijing (CN); Yuxuan Wang, Los Angeles, CA (US)

(21) Appl. No.: 19/207,288

(22) Filed: May 13, 2025

(30) Foreign Application Priority Data
May 15, 2024 (CN) 202410606075.8

(51) Int. Cl. G10L 21/007; G10L 15/06; G10L 15/18

(52) U.S. Cl. CPC G10L 21/007; G10L 15/063; G10L 15/1815

(57) ABSTRACT

Embodiments of the present disclosure relate to a method and apparatus for timbre conversion, an electronic device, and a product. The method includes determining a semantic feature of an audio to be converted, where the audio to be converted has an original timbre. The method further includes acquiring a prompt audio, where the prompt audio has a target timbre different from the original timbre. The method further includes generating, based on the semantic feature of the audio to be converted and the prompt audio, a converted acoustic feature using a self-attention-based diffusion model. Additionally, the method further includes generating a converted audio based on the converted acoustic feature, where the converted audio is an audio in which a timbre of the audio to be converted is converted into the target timbre.

### CROSS-REFERENCE TO RELATED APPLICATION(S)

This application claims priority to Chinese Application No. 202410606075.8 filed on May 15, 2024, the disclosure of which is incorporated herein by reference in its entirety.

### FIELD

The present disclosure generally relates to the field of artificial intelligence, and more specifically, to a method and apparatus for timbre conversion, an electronic device, and a product.

### BACKGROUND

Timbre conversion is a technology that changes timbre characters of a voice, making it sound like another voice. The timbre conversion may be applied in video production, audiobook creation, film dubbing, and other audio-related fields. In some scenarios, the timbre conversion can simply adjust the intonation and vocal texture of audio.

For example, when a user creates a short video using a video editing application, the user may wish to attract viewers and create interesting content by changing the spoken voice. In this scenario, a video creator wishes to use the editing application to convert the voice.

### SUMMARY

Embodiments of the present disclosure provide a method and apparatus for timbre conversion, an electronic device, and a product.

In a first aspect of the embodiments of the present disclosure, a method for timbre conversion is provided. The method includes determining a semantic feature of an audio to be converted, where the audio to be converted has an original timbre. The method further includes acquiring a prompt audio, where the prompt audio has a target timbre different from the original timbre. The method further includes generating, based on the semantic feature of the audio to be converted and the prompt audio, a converted acoustic feature using a self-attention-based diffusion model. Additionally, the method further includes generating a converted audio based on the converted acoustic feature, where the converted audio is an audio in which a timbre of the audio to be converted is converted into the target timbre.

In a second aspect of the embodiments of the present disclosure, an apparatus for timbre conversion is provided. The apparatus includes a semantic feature determination module, configured to determine a semantic feature of an audio to be converted, where the audio to be converted has an original timbre. The apparatus further includes a prompt audio acquiring module, configured to acquire a prompt audio, where the prompt audio has a target timbre different from the original timbre. The apparatus further includes an acoustic feature generation module, configured to generate, based on the semantic feature of the audio to be converted and the prompt audio, a converted acoustic feature using a self-attention-based diffusion model. Additionally, the apparatus further includes a converted audio generation module, configured to generate a converted audio based on the converted acoustic feature, where the converted audio is an audio in which a timbre of the audio to be converted is converted into the target timbre.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for timbre conversion. The method includes determining a semantic feature of an audio to be converted, where the audio to be converted has an original timbre. The method further includes acquiring a prompt audio, where the prompt audio has a target timbre different from the original timbre. The method further includes generating, based on the semantic feature of the audio to be converted and the prompt audio, a converted acoustic feature using a self-attention-based diffusion model. Additionally, the method further includes generating a converted audio based on the converted acoustic feature, where the converted audio is an audio in which a timbre of the audio to be converted is converted into the target timbre.

In a fourth aspect of the embodiments of the present disclosure, a computer program product is provided. The computer program product is tangibly stored on a non-transitory computer-readable medium and includes machine-executable instructions, and the machine-executable instructions, when executed, cause a machine to implement a method for timbre conversion. The method includes determining a semantic feature of an audio to be converted, where the audio to be converted has an original timbre. The method further includes acquiring a prompt audio, where the prompt audio has a target timbre different from the original timbre. The method further includes generating, based on the semantic feature of the audio to be converted and the prompt audio, a converted acoustic feature using a self-attention-based diffusion model. Additionally, the method further includes generating a converted audio based on the converted acoustic feature, where the converted audio is an audio in which a timbre of the audio to be converted is converted into the target timbre.

The section SUMMARY is provided to introduce concept selection in a simplified form, which will be further described in the following specific implementations. The section SUMMARY is not intended to identify key or essential features of the subject claimed for protection, nor is it intended to limit the scope of the subject claimed for protection.

### BRIEF DESCRIPTION OF THE DRAWINGS

The above-mentioned and other features, advantages, and aspects of various embodiments of the present disclosure will become more apparent in conjunction with the accompanying drawings and with reference to following detailed descriptions. In the accompanying drawings, the same or similar reference numerals denote the same or similar elements.

FIG. 1 illustrates a schematic diagram of an example environment where some embodiments of the present disclosure may be implemented;

FIG. 2 illustrates a flowchart of a method for timbre conversion according to some embodiments of the present disclosure;

FIG. 3 illustrates a schematic diagram of an example process for implementing timbre conversion using a self-attention-based diffusion model according to some embodiments of the present disclosure;

FIG. 4 illustrates a schematic diagram of an example architecture of a self-attention-based diffusion model according to some embodiments of the present disclosure;

FIG. 5A to FIG. 5C illustrate schematic diagrams of an example process for training a self-attention-based diffusion model in two phases according to some embodiments of the present disclosure;

FIG. 6 illustrates a block diagram of an apparatus for timbre conversion according to some embodiments of the present disclosure; and

FIG. 7 illustrates a block diagram of an electronic device according to some embodiments of the present disclosure.

In all the accompanying drawings, the same or similar reference numerals denote the same or similar elements.

### DETAILED DESCRIPTION OF EMBODIMENTS

It should be understood that data (including but not limited to the data itself, and data acquisition, or usage) involved in the technical solutions should comply with the requirements of corresponding laws and regulations, and relevant stipulations.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

For example, when an active request from the user is received, a prompt message is sent to the user to clearly prompt the user that an operation requested to be performed will require access to and use of the personal information of the user. As such, the user can independently choose, according to the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt message to the user may be, for example, a pop-up window, in which the prompt message may be presented in text. Additionally, the pop-up window may also carry a selection control for the user to choose whether to “agree” or “disagree” to provide the personal information to the electronic device.

It should be understood that the above-mentioned notification and user authorization obtaining process is only illustrative, which does not limit the implementations of the present disclosure, and other methods that comply with the relevant laws and regulations may also be applied to the implementations of the present disclosure.

It should be noted that a timbre involved in the embodiments of the present disclosure is an existing timbre in a timbre library or a timbre authorized for use.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term “include” and similar terms thereof should be understood as open-ended inclusions, namely, “including but not limited to”. The term “based on” should be understood as “at least partially based on”. The term “an embodiment” or “this embodiment” should be understood as “at least one embodiment”. The terms “first”, “second”, etc. may refer to different or identical objects, unless otherwise explicitly specified. Additional explicit and implicit definitions may also be included below.

As mentioned above, in some scenarios, the user may provide a specific speech as a prompt audio and expect a model to retain a timbre of the prompt audio. Then, the user may provide another audio clip (e.g., a speech of the user) as an audio to be converted, and expect the model to convert a timbre of the audio to be converted into the timbre of the prompt audio. Compared to some scenarios for the generation of audio with specific timbres based on texts, in this scenario, converted audio content (e.g., including text content, a speech rate, an intonation, and a duration) may be the same as content of the audio to be converted, with only the timbre being converted into the timbre in the prompt audio. Additionally, compared to some scenarios where several specific timbres are provided for user selection, in this scenario, the user is allowed to provide any prompt audio and perform timbre conversion without performing model training for the audio. It should be understood that the prompt audio and the timbre thereof are authorized for use.

In some technologies related to timbre conversion, a deep neural network or a generative adversarial network may be used for implementing timbre conversion. However, in the related art, similarity between the timbre of the converted audio and the timbre of the prompt audio is low, and the audio quality of the converted audio is unsatisfactory. The reasons for these problems include an insufficient expressive capability of the model and a semantic feature of the audio to be converted containing some timbre information of the audio to be converted. During model training, the part of information cannot be disregarded, which subsequently leads to inadequate timbre similarity between the converted audio and the prompt audio.

In view of this, an embodiment of the present disclosure provides a solution for timbre conversion using a self-attention-based diffusion model. In the solution, a piece of an audio to be converted and a piece of prompt audio may be acquired, and the objective is to convert a timbre of the audio to be converted (e.g., a timbre of a user) into a timbre of the prompt audio without changing content of the audio to be converted. Then, in the solution, a semantic feature of the audio to be converted may be determined, and based on the semantic feature of the audio to be converted and the prompt audio, a converted acoustic feature is generated using the self-attention-based diffusion model. Then, in the solution, a converted audio may be generated based on the converted acoustic feature, and a timbre of the converted audio is converted into the timbre of the prompt audio.

In this way, an expressive capability of the model can be improved, thereby improving timbre similarity between the converted audio and the prompt audio, and also improving pronounce accuracy of the converted audio. Additionally, in this way, timbre conversion can be achieved by merely providing a piece of prompt audio without pre-training the model for the timbre of the prompt audio, thereby shortening the time and reducing the cost for model training, and also allowing the user to conveniently perform timbre conversion, and then improving user experience.

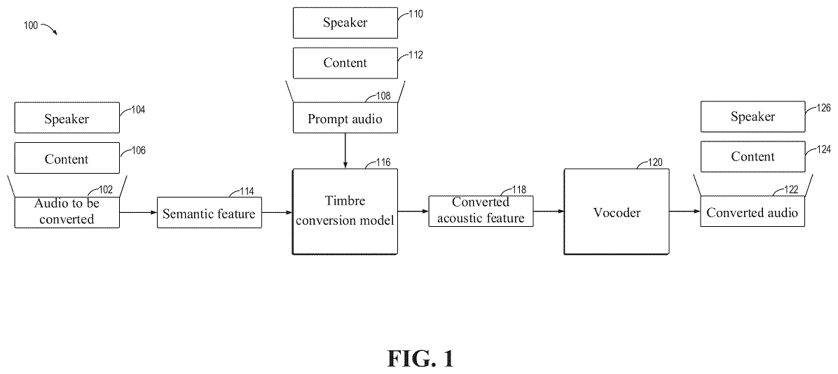

FIG. 1 illustrates a schematic diagram of an example environment 100 where some embodiments of the present disclosure may be implemented. As shown in FIG. 1, the environment 100 includes an audio 102 to be converted and a prompt audio 108. The audio 102 to be converted is a speech segment from a speaker 104 (e.g., the user), with a timbre being that of the voice of the speaker 104. The audio 102 to be converted also includes content 106, and the content 106 may include information such as a text, an intonation, and a speech rate of the audio 102 to be converted. The prompt audio 108 is a speech segment from a speaker 110 (e.g., a character from a movie), with a timbre being that of the voice of the speaker 110. As mentioned above, the timbre is authorized for use. The prompt audio 108 also includes content 112, and the content 112 may include information such as a text, an intonation, and a speech rate of the prompt audio 108.

In the environment 100, a semantic feature 114 may be extracted from the audio 102 to be converted. The semantic feature refers to a feature extracted from an audio signal that can express the meaning of the audio content. For example, the semantic feature may indicate a text, an intonation, and a speech rate of the audio signal. In the environment 100, the semantic feature may be a feature extracted through various methods, such as a HuBERT model, a BEST-RQ model, a model based on an automatic speech recognition (ASR) bottleneck feature, as well as other convolutional neural networks or recurrent neural networks.

After extracting the semantic feature 114 from the audio 102 to be converted, a timbre conversion model 116 may generate a converted acoustic feature 118 based on the semantic feature 114 and the prompt audio 108. The acoustic feature may refer to various physical attributes of sound. For example, the acoustic feature may refer to timbre, frequency, clarity, and loudness of the audio signal.

In this embodiment of the present disclosure, the timbre conversion model 116 may be the self-attention-based diffusion model. The diffusion model is a generative model, which is often used for an image generation task. A workflow of the model includes two processes: a forward process and a reverse process. In the forward process, the model adds noise to data to make the data more random, and in the reverse process, a trained model is used to perform multi-time noise reduction on noised data to restore clean data. Therefore, the diffusion model can generate high-quality data with rich details.

A Transformer model is a representative of a self-attention mechanism, and therefore, the self-attention-based diffusion model may be a Transformer diffusion model. The self-attention mechanism may calculate an attention score of each element in a sequence for other elements, and based on the scores, which parts of an input sequence should be given more attention may be determined when generating each output element. The self-attention mechanism allows the model to simultaneously consider all the elements within the sequence when processing data, thereby effectively capturing a long-range dependency relationship in the data.

By combining a generative capability of the diffusion model with the self-attention mechanism from a Transformer architecture, the timbre conversion model 116 may use contextual information of an entire original acoustic feature to generate a target acoustic feature in a generation process. The method can improve the accuracy and authenticity of the generated converted acoustic feature, as well as the timbre similarity relative to the prompt audio 108.

In the environment 100, after generating the converted acoustic feature 118, a vocoder 120 may generate a converted audio 122 based on the converted acoustic feature 118. The vocoder 120 may be any technology capable of synthesizing an audio based on an acoustic feature, such as a linear predictive coder, a phase vocoder, and a channel vocoder. The generated converted audio 122 has content 124 the same as the content 106 of the audio 102 to be converted, and has a timbre (i.e., a timbre of a speaker 126) the same as a timbre (i.e., the timbre of the speaker 110) of the prompt audio 108, thereby converting the timbre of the audio 102 to be converted into the timbre of the prompt audio 108 while preserving the audio content.

In this way, the timbre similarity between the converted audio 122 and the prompt audio 108 can be improved, and meanwhile the pronounce accuracy of the converted audio 122 can be improved. Additionally, in this way, timbre conversion can be achieved by merely providing a piece of prompt audio 108 without pre-training the timbre conversion model for the speaker 110, thereby shortening the time and reducing the cost for model training, and also allowing the user to conveniently perform timbre conversion, and then improving user experience.

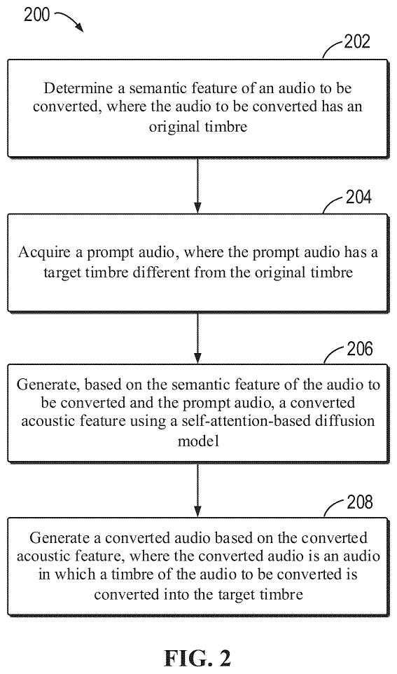

FIG. 2 illustrates a flowchart of a method 200 for timbre conversion according to some embodiments of the present disclosure. At a block 202, in the method 200, a semantic feature of an audio to be converted may be determined, where the audio to be converted has an original timbre. For example, in the environment 100 shown in FIG. 1, the audio 102 to be converted may be acquired, and includes the timbre of the speaker 104 (also referred to as the original timbre), and the content 106. The content 106 may include information such as a text, an annotation, and a speech rate of the audio 102 to be converted. In the environment 100, the semantic feature 114 may be extracted from the audio 102 to be converted through any technology. The semantic feature 114 may refer to information such as a text, an intonation, and a speech rate of the audio 102 to be converted.

At a block 204, in the method 200, a prompt audio may be acquired, where the prompt audio has a target timbre different from the original timbre. For example, in the environment 100 shown in FIG. 1, the prompt audio 108 may be acquired, and includes the timbre of the speaker 110 (also referred to as the target timbre), and the content 112. The content 112 may include information such as a text, an annotation, and a speech rate of the prompt audio 108. As mentioned above, the target timbre is an authorized timbre that can be used by the speaker 110 or relevant authorized entities.

At a block 206, in the method 200, based on the semantic feature of the audio to be converted and the prompt audio, a converted acoustic feature may be generated using the self-attention-based diffusion model. For example, in the environment 100 shown in FIG. 1, based on the semantic feature 114 of the audio 102 to be converted and the prompt audio 108, the converted acoustic feature 118 may be generated using the timbre conversion model 116, where the timbre conversion model 116 is the self-attention-based diffusion model.

At a block 208, in the method 200, a converted audio may be generated based on the converted acoustic feature, where the converted audio is an audio in which a timbre of the audio to be converted is converted into the target timbre. For example, in the environment 100 shown in FIG. 1, based on the converted acoustic feature 118, the converted audio 122 may be generated using the vocoder 120. The vocoder 120 may be any technology capable of generating an audio based on an acoustic feature. The converted audio 122 has the timbre of the speaker 126, and the timbre of the speaker 126 is the same as the timbre of the speaker 110 of the prompt audio 108. Additionally, the converted audio 122 includes the content 124, and the content 124 is the same as the content 106 of the audio 102 to be converted.

In this way, the timbre similarity between the converted audio and the prompt audio can be improved, and meanwhile the pronounce accuracy of the converted audio can be improved. Additionally, in this way, timbre conversion can be achieved by merely providing a piece of prompt audio without pre-training the timbre conversion model for the speaker, thereby shortening the time and reducing the cost for model training, and also allowing the user to conveniently perform timbre conversion, and then improving user experience.

In some embodiments, to further improve the timbre similarity between the converted audio and the prompt audio, as well as the pronounce accuracy of the converted audio, the converted acoustic feature may be generated using multi-modal information from the audio to be converted and the prompt audio, along with cross-scale information within individual modalities in the timbre conversion process. In some embodiments, when generating the converted acoustic feature, a text embedding associated with a prompt text of the prompt audio and an original text of the audio to be converted, a semantic embedding associated with a prompt semantic feature of the prompt audio and an original semantic feature of the audio to be converted, a global timbre embedding associated with the prompt audio, and a local timbre embedding associated with the prompt audio can be determined. Then, the converted acoustic feature may be generated based on the text embedding, the semantic embedding, the global timbre embedding, and the local timbre embedding.

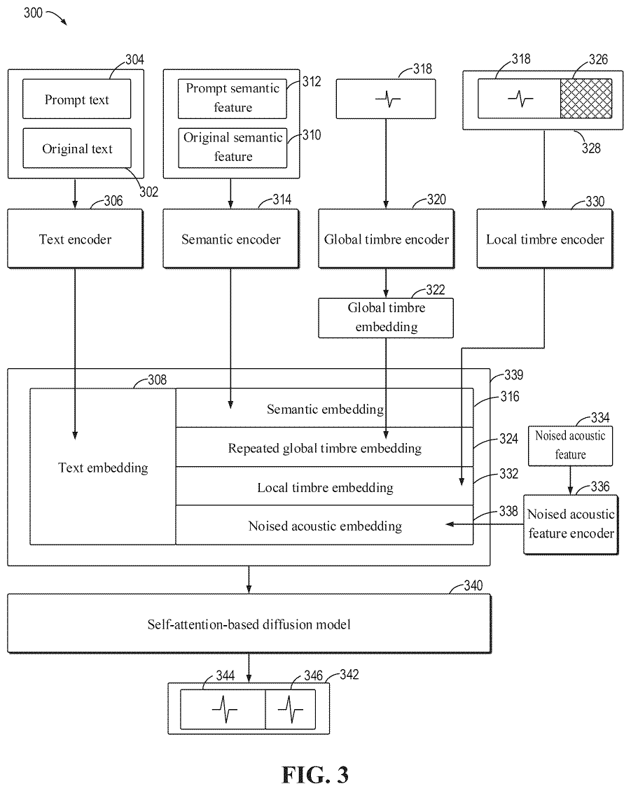

FIG. 3 illustrates a schematic diagram of an example process 300 for implementing timbre conversion using a self-attention-based diffusion model according to some embodiments of the present disclosure. As shown in FIG. 3, in the process 300, an original text 302 (i.e., content spoken by a speaker in an audio to be converted, also referred to as a text to be synthesized) and an original semantic feature 310 may be extracted from the audio to be converted, and a prompt text 304 (i.e., content spoken by a speaker in prompt audio) and a prompt semantic feature 312 may be extracted from the prompt audio. Additionally, in the process 300, a prompt acoustic feature 318 may also be extracted from the prompt audio. In some related art, an audio with a specified timbre may be generated merely based on the prompt semantic feature 312 and the original semantic feature 310. However, the audio generated in this way has low timbre similarity with the prompt audio and also has low pronounce accuracy. Accordingly, in the process 300, the prompt semantic feature 312 and the original semantic feature 310 may serve as a framework to be fused with multimodal information (i.e., a text and a timbre) and multi-scale information within a single modality (i.e., global timbre information and local timbre information) to generate a timbre-converted audio, thereby improving the timbre similarity and the pronounce accuracy.

As shown in FIG. 3, in the process 300, a text encoder 306 may generate a text embedding 308 based on the original text 302 and the prompt text 304. A size of the text embedding 308 is [T1+T2, C], where T1 represents a length of the prompt text, T2 represents a length of the original text, C presents a specific vector dimension, and [T1+T2, C] may represent T1+T2 vectors, each with a dimension of C. A model structure of the text encoder 306 may be a convolutional neural network with padding. The padding may adjust an output size of a convolutional layer and can avoid information losses. Additionally, the text encoder 306 may also be a Transformer. In this way, text information can be provided for generating the timbre-converted audio, and the text information can improve the pronounce accuracy of the generated audio.

As shown in FIG. 3, a global timbre encoder 320 may generate a global timbre embedding 322 based on global information of the prompt acoustic feature 318. The global information refers to all information of the acoustic feature. In some embodiments, when generating the global timbre embedding 322, the global timbre embedding 322 may be generated by taking the prompt acoustic feature 318 as a whole in a time dimension, where the size of the generated global timbre embedding 322 is [1, C]. In this way, global-scale timbre information can be provided for generating the timbre-converted audio, thereby enriching an information scale related to the timbre, and increasing the authenticity and timbre similarity of the generated audio.

An input of the global timbre encoder 320 is a segment of acoustic feature, and an output is a vector without a time dimension (or may also be understood as a time dimension of 1). In some embodiments, an ECAPA-TDNN structure may be used to implement the global timbre encoder 320. ECAPA-TDNN is a neural network structure that incorporates an attention mechanism based on a time-delay neural network (TDNN). By using the structure for implementing the global timbre encoder 320, the global timbre encoder 320 can effectively learn feature dependency relationships in the time dimension, and can improve a feature representation capability by dynamically adjusting the importance of features across different channels, thereby capturing speech features in different time scales and enhancing a capability of the encoder in recognizing a speech mode.

As shown in FIG. 3, in the process 300, the prompt acoustic feature 318 and an acoustic feature 326 to be synthesized may be concatenated to generate an acoustic feature 328. In this case, since the acoustic feature 326 to be synthesized is unknown (i.e., a portion that the model needs to predict), a specific initial value (i.e., a placeholder) may be used to initialize the acoustic feature 326 to be synthesized. Then, a local timbre encoder 330 may generate a local timbre embedding 332 based on local information of the acoustic feature 328. The local information refers to information about a portion of feature within the acoustic feature, such as an acoustic feature corresponding to one or some of all audio frames. In some embodiments, when generating the local timbre embedding 332, the acoustic feature 328 may be split into a plurality of local acoustic features according to the time dimension, and then the local timbre embedding 332 may be generated based on the plurality of local acoustic features. A size of the generated local timbre embedding 332 is [T3+T4, C], where T3 represents a length of the prompt acoustic feature 318 of the prompt audio, and T4 represents a length of the acoustic feature 326 to be synthesized. The local timbre encoder 330 may include, for example, one or more fully connected layers to ensure that the generated embedding has a dimension of C.

In this way, the acoustic feature 328 is split into T3+T4 local acoustic features, a corresponding timbre embedding is generated for each local acoustic feature and is combined into the local timbre embedding 332, and local-scale timbre information can be provided for the generation of the timbre-converted audio, thereby enriching the timbre information scale in the generation process, and increasing the authenticity and timbre similarity of the generated audio.

As shown in FIG. 3, in the process 300, a semantic encoder 314 may generate a semantic embedding 316 based on the original semantic feature 310 and the prompt semantic feature 312. A size of the semantic embedding 316 is [T3+T4, C], which is the same as the size of the local timbre embedding 332. An input of the semantic encoder is a concatenated semantic feature generated by concatenating the original semantic feature 310 and the prompt semantic feature 312. A length of the concatenated semantic feature may differ from that of the acoustic feature (i.e., the prompt acoustic feature 318 and the acoustic feature 328). For example, the semantic feature may have a sampling rate of 20 sampling points per second, while the acoustic feature may have a sampling rate of 40 sampling points per second. When the semantic feature and the acoustic feature are different in length, the semantic encoder may perform upsampling (e.g., using a deconvolutional layer), downsampling (e.g., using a convolutional layer), or combined upsampling and downsampling on the semantic feature, thereby allowing the frequency of the output semantic embedding 316 (i.e., the number of sampling points per second) to be consistent with the frequency of the acoustic feature. In this way, the size of the generated semantic embedding 316 can be aligned with the size of the local timbre embedding 332, thereby facilitating subsequent information fusion.

As mentioned above, the size of the global timbre embedding 322 is [1, C]. For the information fusion, in the process 300, the global timbre embedding 322 may be repeated T3+T4 times in the time dimension, to generate a repeated global timbre embedding 324 with a size of [T3+T4, C]. Accordingly, on one hand, the repeated global timbre embedding 324 includes T3+T4 repeated vectors, each with a dimension of C, where each vector is generated based on all information of the prompt acoustic feature 318. On the other hand, the local timbre embedding 332 includes T3+T4 different vectors, each with a dimension of C, where each vector is generated based on information about one audio frame (or one sampling point) in the acoustic feature 328. Therefore, global-scale and local-scale timbre information can be provided.

To restore a predicted acoustic feature from noise, in the process 300, a noised acoustic feature 334 may be generated, and a noised acoustic feature encoder 336 is used to convert the noised acoustic feature 334 into a noised acoustic embedding 338 with a size of [T3+T4, C]. Then, in the process 300, the semantic embedding 316, the repeated global timbre embedding 324, the local timbre embedding 332, and the noised acoustic embedding 338, all of which have the size of [T3+T4, C] may be summed, to generate a fused acoustic embedding with a size of [T3+T4, C]. Then, in the process 300, the generated fused acoustic embedding and the text embedding 308 with the size of [T1+T2, C] may be concatenated in time, to generate a fused multimodal embedding 339 with a size of [T1+T2+T3+T4, C].

As shown in FIG. 3, a self-attention-based diffusion model 340 may generate a predicted acoustic feature 342 based on the fused multimodal embedding 339. The predicted acoustic feature 342 includes a predicted acoustic feature 344 corresponding to the prompt acoustic feature 318 and a predicted acoustic feature 346 corresponding to the acoustic feature 326 to be synthesized. In the process 300, the predicted acoustic feature 344 corresponding to the prompt acoustic feature 318 may be discarded, and only the predicted acoustic feature 346 corresponding to the acoustic feature 326 to be synthesized is retained.

In a training process, the noised acoustic feature 334 may be generated by adding noise to a true value of a timbre-converted acoustic feature. Then, a loss between the predicted acoustic feature 346 and the true value may be calculated, and then the self-attention-based diffusion model 340, the text encoder 306, the semantic encoder 314, the global timbre encoder 320, and the local timbre encoder 330 are jointly trained based on the loss.

In an inference process, the noised acoustic feature 334 may be generated based on random noise. The predicted acoustic feature 346 is a timbre-converted acoustic feature (e.g., the converted acoustic feature 118 in FIG. 1) generated after performing multi-time denoising on the random noise. Then, based on the predicted acoustic feature 346, a timbre-converted audio may be generated using a vocoder.

In this way, the self-attention-based diffusion model 340 can perform timbre conversion based on multimodal information (i.e., a text and a timbre) and multi-scale information within a single modality (i.e., global timbre information and local timbre information). Accordingly, the text information can aid the model in improving the pronounce accuracy of the converted audio, and multi-scale timbre information can help the model to improve the timbre similarity.

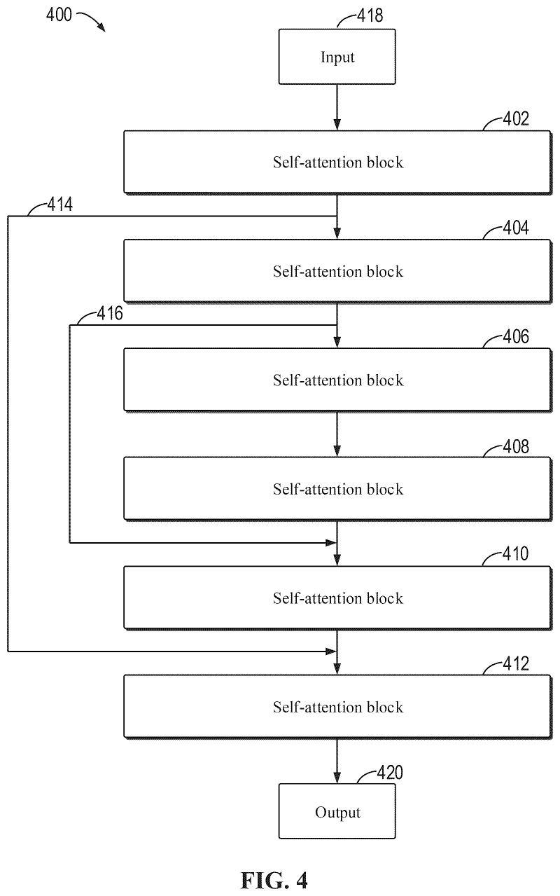

FIG. 4 illustrates a schematic diagram of an example architecture 400 of a self-attention-based diffusion model according to some embodiments of the present disclosure. As shown in FIG. 4, the architecture 400 includes self-attention blocks 402, 404, 406, 408, 410, and 412, and each self-attention block may have a Transformer architecture. In the architecture 400, these self-attention blocks are connected in series. That is, an output of each self-attention block located above serves as at least a portion of an input to its adjacent self-attention block below. The architecture 400 further includes a plurality of skip connections. For example, the output of the self-attention block 402 is connected to the self-attention block 412 via the skip connection 414, and the output of the self-attention block 404 is connected to the self-attention block 410 via the skip connection 416.

In the architecture 400, the self-attention-based diffusion model receives an input 418 and generates an output 420. The architecture 400 inputs the input 418 into the self-attention block 402. Each self-attention block may independently process input data and use the Transformer architecture to extract and learn high-level features. The self-attention mechanism can process global information across the entire input sequence, thereby allowing the model to better understand and represent a complex mode and a relationship within the input 418. The serial connection between the self-attention blocks allows the information to flow from top to bottom within the model. Each block may further process and refine features based on the previous block, and the method can gradually enhance a data representation capability.

The skip connections in the architecture 400 can allow information from previous blocks not to be forgotten by subsequent blocks, thereby alleviating a vanishing gradient problem in an architecture network. Additionally, these skip connections can also facilitate the rapid propagation of the features, aiding in the direct transmission of key information between various blocks, which can improve the efficiency and stability of the model.

In a training and inference process of a timbre conversion model, a semantic feature of an audio to be converted is a framework for generating a converted audio. However, the semantic feature of the audio to be converted (e.g., the original semantic feature 310 in FIG. 3) inevitably includes some timbre information, and the timbre information of the audio to be converted may influence the timbre similarity between the converted audio and a prompt audio. In some related art, an engineer needs to carefully select semantic features that contain less timbre information and generate an audio based on the selected semantic features. However, the selected semantic features still contain the timbre information. Since the available semantic features are limited, an effect of the generated audio will be reduced.

Accordingly, in some embodiments, the timbre conversion model may be trained using a two-phase training process. In some embodiments, a semantic feature of a training audio may be determined. In a first training phase, an untrained self-attention-based diffusion model may be pre-trained based on the training audio and the semantic feature of the training audio. After the first training phase, based on the training audio and a random audio, a timbre-changed semantic feature is generated using the pre-trained self-attention-based diffusion model, where a timbre of the random audio is different from a timbre of the training audio. In a second training phase, the pre-trained self-attention-based diffusion model may be trained based on the training audio and the timbre-changed semantic feature.

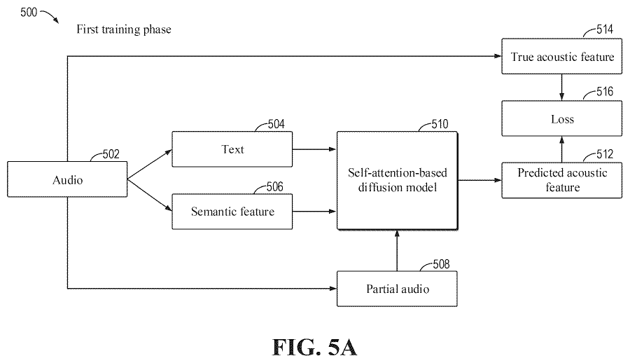

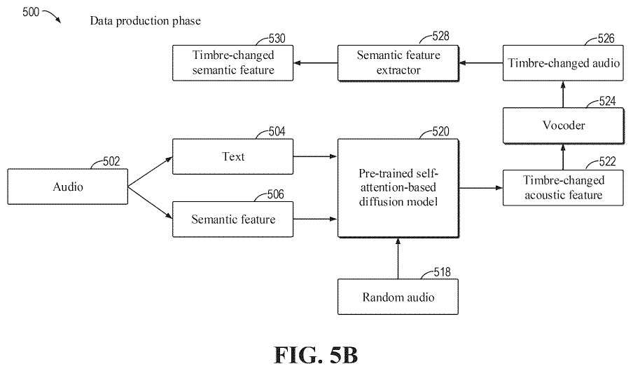

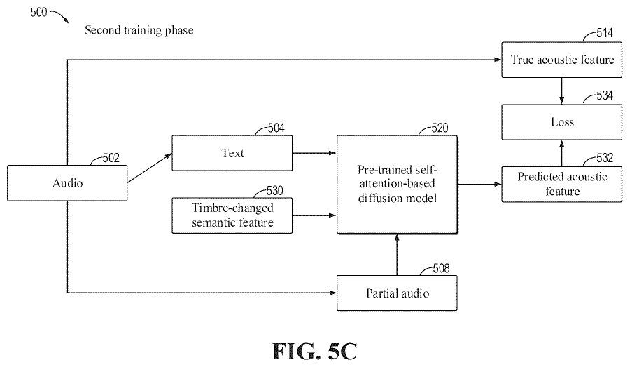

FIG. 5A to FIG. 5C illustrate schematic diagrams of an example process 500 for training a self-attention-based diffusion model in two phases according to some embodiments of the present disclosure. FIG. 5A illustrates a process of pre-training the model in a first phase, FIG. 5B illustrates a process of generating a timbre-changed semantic feature using the pre-trained model, and FIG. 5C illustrates a process of further training the pre-trained model using the generated timbre-changed semantic feature.

As shown in FIG. 5A, in the first training phase, in the process 500, an audio 502 to be converted that serves as training sample may be acquired, where the audio 502 may be a speech segment from a specific speaker. In the process 500, a text 504 and a semantic feature 506 (i.e., a semantic feature to be converted) may be extracted from the audio 502, and the semantic feature 506 may be any semantic feature extracted from the audio 502, and may include timbre information of the audio 502. Then, in the process 500, a partial audio 508 may be randomly cropped from the audio 502 to serve as a prompt audio. Then, a self-attention-based diffusion model 510 may generate a predicted acoustic feature 512 (also referred to as a first predicted acoustic feature) based on the text 504, the semantic feature 506, and the partial audio 508, and for the process, reference may be made to the process 300 shown in FIG. 3.

In the process 500, a true acoustic feature 514 may also be extracted from the audio 502 to serve as a ground truth. Then, in the process 500, the self-attention-based diffusion model 510 may be pre-trained by calculating a loss 516 between the predicted acoustic feature 512 and the true acoustic feature 514 and minimizing the loss 516. Accordingly, after the completion of the first training phase, a pre-trained self-attention-based diffusion model 520 (as shown in FIG. 5B) may be obtained. In this case, since the semantic feature 506 includes the timbre information of the audio 502, the predicted acoustic feature 512 also includes some timbre information of the audio 502, which will degrade timbre similarity of a converted audio.

As shown in FIG. 5B, after completing the first training phase, the process 500 proceeds to a data production phase. In the data production phase, in the process 500, a random audio 518 may be acquired, and a timbre (i.e., a speaker) of the random audio 518 is different from a timbre of the audio 502. The pre-trained self-attention-based diffusion model 520 may generate a timbre-changed acoustic feature 522 based on the text 504 and the semantic feature 506 of the audio 502, as well as the random audio 518 (i.e., serving as the prompt audio), and for the process, reference may be made to the process 300 shown in FIG. 3. In this case, timbre information in the timbre-changed acoustic feature 522 fuses timbre information of the semantic feature 506 and timbre information of the random audio 518, and therefore the timbre of the timbre-changed acoustic feature 522 is changed and is different from the timbre of the audio 502. It should be understood that data involved in the present disclosure (including but not limited to the data itself and the access to or use of the data) shall comply with the requirements of corresponding laws, regulations, and relevant provisions.

As shown in FIG. 5B, in the process 500, a vocoder 524 may be used to generate a timbre-changed audio 526 based on the timbre-changed acoustic feature 522. Then, in the process 500, a semantic feature extractor 528 may be used to generate a timbre-changed semantic feature 530 based on the timbre-changed audio 526. In this way, the timbre-changed semantic feature 530 may be generated based on the semantic feature 506, and the timbre-changed semantic feature 530 can have timbre information different from that of the semantic feature 506.

After completing the data production phase, the process 500 may proceed to a second training phase. As shown in FIG. 5C, compared to the first training phase in FIG. 5A, the pre-trained self-attention-based diffusion model may generate a predicted acoustic feature 532 based on the timbre-changed semantic feature 530 (rather than the semantic feature 506), the text 504 of the audio 502, and the partial audio 508. Then, in the process 500, the pre-trained self-attention-based diffusion model 520 may be further trained by calculating a loss 534 between the predicted acoustic feature 532 and the true acoustic feature 514 and minimizing the loss 534.

By training the model in this way, since the timbre-changed semantic feature 530 does not include the timbre information of the audio 502, when generating a timbre-converted audio, the trained self-attention-based diffusion model can ignore an original timbre in the audio to be converted, thereby improving the timbre similarity between the converted audio and the prompt audio.

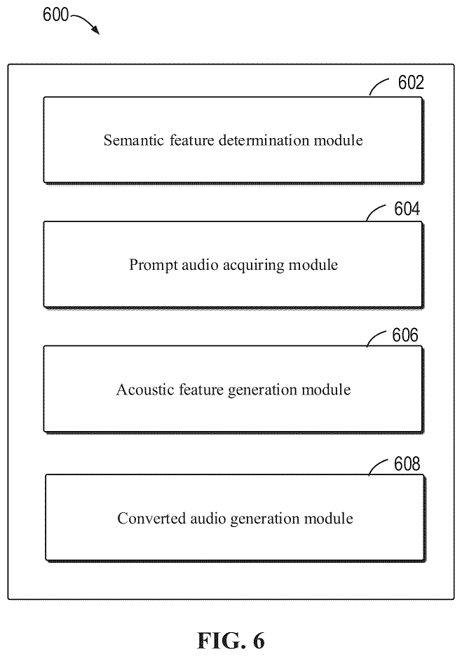

FIG. 6 illustrates a block diagram of an apparatus 600 for timbre conversion according to some embodiments of the present disclosure. As shown in FIG. 6, the apparatus 600 includes a semantic feature determination module 602, configured to determine a semantic feature of an audio to be converted, where the audio to be converted has an original timbre. The apparatus 600 further includes a prompt audio acquiring module 604, configured to acquire a prompt audio, where the prompt audio has a target timbre different from the original timbre. The apparatus 600 further includes an acoustic feature generation module 606, configured to generate, based on the semantic feature of the audio to be converted and the prompt audio, a converted acoustic feature using a self-attention-based diffusion model. Additionally, the apparatus 600 further includes a converted audio generation module 608, configured to generate a converted audio based on the converted acoustic feature, where the converted audio is an audio in which a timbre of the audio to be converted is converted into the target timbre.

It should be understood that by using the apparatus 600 in the present disclosure, at least one of the many advantages capable of being implemented in the methods or the processes described above may be achieved. For example, the apparatus 600 can improve timbre similarity between the converted audio and the prompt audio, and can also improve the pronounce accuracy of the converted audio. Additionally, the apparatus 600 can also achieve timbre conversion by merely providing a piece of prompt audio without pre-training the model for the timbre of the prompt audio, thereby shortening the time and reducing the cost for model training, and also allowing the user to conveniently perform timbre conversion, and then improving user experience.

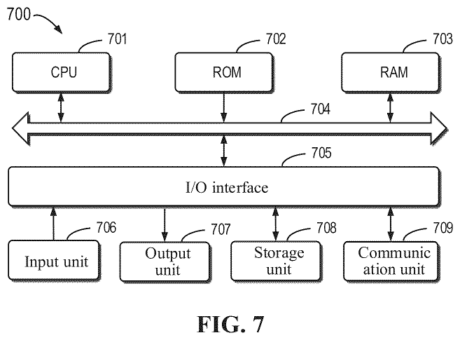

FIG. 7 illustrates a block diagram of an electronic device 700 according to some embodiments of the present disclosure. The device 700 may be a device or apparatus described in the embodiments of the present disclosure. As shown in FIG. 7, the device 700 includes a central processing unit (CPU) and/or a graphics processing unit (GPU) 701, which may perform various suitable actions and processing according to computer program instructions stored in a read-only memory (ROM) 702 or computer program instructions loaded from a storage unit 708 into a random access memory (RAM) 703. The RAM 703 may also store various programs and data required for the operation of the device 700. The CPU/GPU 701, the ROM 702, and the RAM 703 are connected to one another through a bus 704. An input/output (I/O) interface 705 is also connected to the bus 704. Although not shown in FIG. 7, the device 700 may also include a coprocessor.

A plurality of components in the device 700 are connected to the I/O interface 705, including an input unit 706 such as a keyboard and a mouse; an output unit 707 such as various types of displays and speakers; the storage unit 708 such as a disk and an optical disk; and a communication unit 709 such as a network card, a modem, and a wireless communication transceiver. The communication unit 709 allows the device 700 to exchange information/data with other devices through a computer network such as the Internet, and/or various telecommunication networks.

The various methods or processes described above may be performed by the CPU/GPU 701. For example, in some embodiments, the method may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded onto the RAM 703 and executed by the CPU/GPU 701, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., utilizing an Internet service provider for Internet connectivity). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or the another programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above-mentioned description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or technology improvements to technologies on the market, or to allow other persons of ordinary skill in the art to understand the various embodiments disclosed herein.

Some example implementations of the present disclosure are listed below.

Example 1. A method for timbre conversion, including:
determining a semantic feature of an audio to be converted, where the audio to be converted has an original timbre;
acquiring a prompt audio, where the prompt audio has a target timbre different from the original timbre;
generating, based on the semantic feature of the audio to be converted and the prompt audio, a converted acoustic feature using a self-attention-based diffusion model; and
generating a converted audio based on the converted acoustic feature, where the converted audio is an audio in which a timbre of the audio to be converted is converted into the target timbre.

Example 2. The method according to Example 1, where the semantic feature of the audio to be converted is an original semantic feature, and generating, based on the semantic feature of the audio to be converted and the prompt audio, the converted acoustic feature using the self-attention-based diffusion model includes:
determining a text embedding associated with a prompt text of the prompt audio and an original text of the audio to be converted;
determining a semantic embedding associated with a prompt semantic feature of the prompt audio and the original semantic feature of the audio to be converted;
determining a global timbre embedding associated with the prompt audio;
determining a local timbre embedding associated with the prompt audio; and
generating the converted acoustic feature based on the text embedding, the semantic embedding, the global timbre embedding, and the local timbre embedding.

Example 3. The method according to Examples 1 to 2, where determining the text embedding associated with the prompt text of the prompt audio and the original text of the audio to be converted includes:
generating, based on the prompt text and the original text, the text embedding using a text encoder.

Example 4. The method according to Examples 1 to 3, where determining the semantic embedding associated with the prompt semantic feature of the prompt audio and the original semantic feature of the audio to be converted includes:
generating, based on the prompt semantic feature and the original semantic feature, the semantic embedding using a semantic encoder.

Example 5. The method according to Examples 1 to 4, where determining the global timbre embedding associated with the prompt audio includes:
determining a prompt acoustic feature of the prompt audio; and
generating, based on the prompt acoustic feature, the global timbre embedding by using a global timbre encoder and taking the prompt acoustic feature as a whole in a time dimension.

Example 6. The method according to Examples 1 to 5, where determining the local timbre embedding associated with the prompt audio includes:
determining a prompt acoustic feature of the prompt audio;
splitting the prompt acoustic feature into a plurality of local acoustic features in a time dimension; and
generating, based on the plurality of local acoustic features, the local timbre embedding using a local timbre encoder.

Example 7. The method according to Examples 1 to 6, where generating the converted acoustic feature based on the text embedding, the semantic feature embedding, and the timbre embedding includes:
generating a random noise;
generating, based on the random noise, a noised acoustic embedding using a noised acoustic feature encoder;
generating a fused embedding based on the text embedding, the semantic embedding, the global timbre embedding, the local timbre embedding, and the noised acoustic embedding; and
generating, based on the fused embedding, the converted acoustic feature using the self-attention-based diffusion model.

Example 8. The method according to Examples 1 to 7, where a process of training the self-attention-based diffusion model includes:
determining a semantic feature of a training audio;
in a first training phase, pre-training an untrained self-attention-based diffusion model based on the training audio and the semantic feature of the training audio;
after the first training phase, generating, based on the training audio and a random audio, a timbre-changed semantic feature using a pre-trained self-attention-based diffusion model, where a timbre of the random audio is different from a timbre of the training audio; and
in a second training phase, training the pre-trained self-attention-based diffusion model based on the training audio and the timbre-changed semantic feature.

Example 9. The method according to Examples 1 to 8, where in the first training phase, pre-training the self-attention-based diffusion model based on the training audio and the semantic feature of the training audio includes:
extracting a partial audio from the training audio;
generating, based on the semantic feature of the training audio and the partial audio, a first predicted acoustic feature using the untrained self-attention-based diffusion model;
determining an acoustic feature of the training audio; and
pre-training the untrained self-attention-based diffusion model by calculating a loss between the first predicted acoustic feature and the acoustic feature of the training audio.

Example 10. The method according to Examples 1 to 9, where after the first training phase, generating, based on the training audio and the random audio, the timbre-changed semantic feature using the pre-trained self-attention-based diffusion model includes:
generating, based on the semantic feature of the training audio and the random audio, a timbre-changed acoustic feature using the pre-trained self-attention-based diffusion model; and
generating the timbre-changed semantic feature based on the timbre-changed acoustic feature.

Example 11. The method according to Examples 1 to 10, where generating the timbre-changed semantic feature based on the timbre-changed acoustic feature includes:
generating a timbre-changed audio based on the timbre-changed acoustic feature; and
generating the timbre-changed semantic feature based on the timbre-changed audio.

Example 12. The method according to Examples 1 to 11, where in the second training phase, training the pre-trained self-attention-based diffusion model based on the training audio and the timbre-changed semantic feature includes:
extracting a partial audio from the training audio;
generating, based on the timbre-changed semantic feature and the partial audio, a second predicted acoustic feature using the pre-trained self-attention-based diffusion model;
determining an acoustic feature of the training audio; and
training the pre-trained self-attention-based diffusion model by calculating a loss between the second predicted acoustic feature and the acoustic feature of the training audio.

Example 13. An apparatus for timbre conversion, including:
a semantic feature determination module, configured to determine a semantic feature of an audio to be converted, where the audio to be converted has an original timbre;
a prompt audio acquiring module, configured to acquire a prompt audio, where the prompt audio has a target timbre different from the original timbre;
an acoustic feature generation module, configured to generate, based on the semantic feature of the audio to be converted and the prompt audio, a converted acoustic feature using a self-attention-based diffusion model; and
a converted audio generation module, configured to generate a converted audio based on the converted acoustic feature, where the converted audio is an audio in which a timbre of the audio to be converted is converted into the target timbre.

Example 14. The apparatus according to Example 13, where the acoustic feature generation module includes:
a text embedding determination module, configured to determine a text embedding associated with a prompt text of the prompt audio and an original text of the audio to be converted;
a semantic embedding determination module, configured to determine a semantic embedding associated with a prompt semantic feature of the prompt audio and the original semantic feature of the audio to be converted;
a global timbre embedding determination module, configured to determine a global timbre embedding associated with the prompt audio;
a local timbre embedding determination module, configured to determine a local timbre embedding associated with the prompt audio; and
a multimodal embedding use module, configured to generate the converted acoustic feature based on the text embedding, the semantic embedding, the global timbre embedding, and the local timbre embedding.

Example 15. The apparatus according to Examples 13 to 14, where the text embedding determination module includes:
a text encoder use module, configured to generate, based on the prompt text and the original text, the text embedding using a text encoder.

Example 16. The apparatus according to Examples 13 to 15, where the semantic embedding determination module includes:
a semantic encoder use module, configured to generate, based on the prompt semantic feature and the original semantic feature, the semantic embedding using a semantic encoder.

Example 17. The apparatus according to Examples 13 to 16, where the global timbre embedding determination module includes:
a first prompt acoustic feature determination module, configured to determine a prompt acoustic feature of the prompt audio; and
a prompt acoustic feature use module, configured to take, based on the prompt acoustic feature, the prompt acoustic feature as a whole to generate the global timbre embedding using a global timbre encoder in a time dimension.

Example 18. The apparatus according to Examples 13 to 17, where the local timbre embedding determination module includes:
a second prompt acoustic feature determination module, configured to determine a prompt acoustic feature of the prompt audio;
a local acoustic feature generation module, configured to split the prompt acoustic feature into a plurality of local acoustic features in a time dimension; and
a local acoustic feature use module, configured to generate, based on the plurality of local acoustic features, the local timbre embedding using a local timbre encoder.

Example 19. The apparatus according to Examples 13 to 18, where the multimodal embedding use module includes:
a random noise generation module, configured to generate random noise;
a random noise use module, configured to generate, based on the random noise, a noised acoustic embedding using a noised acoustic feature encoder;
a fused embedding generation module, configured to generate a fused embedding based on the text embedding, the semantic embedding, the global timbre embedding, the local timbre embedding, and the noised acoustic embedding; and
a fused embedding use module, configured to generate, based on the fused embedding, the converted acoustic feature using the self-attention-based diffusion model.

Example 20. The apparatus according to Examples 13 to 19, where a process of training the self-attention-based diffusion model includes:
a training semantic feature determination module, configured to determine a semantic feature of a training audio;
a first training module, configured to pre-train, in a first training phase, an untrained self-attention-based diffusion model based on the training audio and the semantic feature of the training audio;
a data generation module, configured to generate, based on the training audio and a random audio, a timbre-changed semantic feature using a pre-trained self-attention-based diffusion model after the first training phase, where a timbre of the random audio is different from a timbre of the training audio; and
a second training module, configured to train, in a second training phase, the pre-trained self-attention-based diffusion model based on the training audio and the timbre-changed semantic feature.

Example 21. The apparatus according to Examples 13 to 20, where the first training module includes:
a first partial audio extraction module, configured to extract partial audio from the training audio;
a first predicted acoustic feature generation module, configured to generate, based on the semantic feature of the training audio and the partial audio, a first predicted acoustic feature using the untrained self-attention-based diffusion model;
a first training acoustic feature determination module, configured to determine an acoustic feature of the training audio; and
a first predicted acoustic feature use module, configured to pre-train the untrained self-attention-based diffusion model by calculating a loss between the first predicted acoustic feature and the acoustic feature of the training audio.

Example 22. The apparatus according to Examples 13 to 21, where the data generation module includes:
a timbre-changed acoustic feature generation module, configured to generate, based on the semantic feature of the training audio and the random audio, a timbre-changed acoustic feature using the pre-trained self-attention-based diffusion model; and
a timbre-changed semantic feature generation module, configured to generate the timbre-changed semantic feature based on the timbre-changed acoustic feature.

Example 23. The apparatus according to Examples 13 to 22, where the timbre-changed semantic feature generation module includes:
a timbre-changed audio generation module, configured to generate timbre-changed audio based on the timbre-changed acoustic feature; and
a timbre-changed audio use module, configured to generate the timbre-changed semantic feature based on the timbre-changed audio.

Example 24. The apparatus according to Examples 13 to 23, where the second training module includes:
a second partial audio extraction module, configured to extract partial audio from the training audio;
a second predicted acoustic feature generation module, configured to generate, based on the timbre-changed semantic feature and the partial audio, a second predicted acoustic feature using the pre-trained self-attention-based diffusion model;
a second training acoustic feature determination module, configured to determine an acoustic feature of the training audio; and
a second predicted acoustic feature use module, configured to train the pre-trained self-attention-based diffusion model by calculating a loss between the second predicted acoustic feature and the acoustic feature of the training audio.

Example 25. An electronic device, including:
a processor; and
a memory coupled with the processor, where the memory has instructions stored therein, the instructions, when executed by the processor, cause the electronic device to perform actions, and the actions include:
determining a semantic feature of an audio to be converted, where the audio to be converted has an original timbre;
acquiring a prompt audio, where the prompt audio has a target timbre different from the original timbre;
generating, based on the semantic feature of the audio to be converted and the prompt audio, a converted acoustic feature using a self-attention-based diffusion model; and
generating a converted audio based on the converted acoustic feature, where the converted audio is an audio in which a timbre of the audio to be converted is converted into the target timbre.

Example 26. The method according to Example 25, where the semantic feature of the audio to be converted is an original semantic feature, and generating, based on the semantic feature of the audio to be converted and the prompt audio, the converted acoustic feature using the self-attention-based diffusion model includes:
determining a text embedding associated with a prompt text of the prompt audio and an original text of the audio to be converted;
determining a semantic embedding associated with a prompt semantic feature of the prompt audio and the original semantic feature of the audio to be converted;
determining a global timbre embedding associated with the prompt audio;
determining a local timbre embedding associated with the prompt audio; and
generating the converted acoustic feature based on the text embedding, the semantic embedding, the global timbre embedding, and the local timbre embedding.

Example 27. The method according to Examples 25 to 26, where determining the text embedding associated with the prompt text of the prompt audio and the original text of the audio to be converted includes:
generating, based on the prompt text and the original text, the text embedding using a text encoder.

Example 28. The method according to Examples 25 to 27, where determining the semantic embedding associated with the prompt semantic feature of the prompt audio and the original semantic feature of the audio to be converted includes:
generating, based on the prompt semantic feature and the original semantic feature, the semantic embedding using a semantic encoder.

Example 29. The method according to Examples 25 to 28, where determining the global timbre embedding associated with the prompt audio includes:
determining a prompt acoustic feature of the prompt audio; and
generating, based on the prompt acoustic feature, the global timbre embedding by using a global timbre encoder and taking the prompt acoustic feature as a whole in a time dimension.

Example 30. The method according to Examples 25 to 29, where determining the local timbre embedding associated with the prompt audio includes:
determining a prompt acoustic feature of the prompt audio; and
splitting the prompt acoustic feature into a plurality of local acoustic features in a time dimension; and
generating, based on the plurality of local acoustic features, the local timbre embedding using a local timbre encoder.

Example 31. The method according to Examples 25 to 30, where generating the converted acoustic feature based on the text embedding, the semantic feature embedding, and the timbre embedding includes:
generating a random noise;
generating, based on the random noise, a noised acoustic embedding using a noised acoustic feature encoder;
generating a fused embedding based on the text embedding, the semantic embedding, the global timbre embedding, the local timbre embedding, and the noised acoustic embedding; and
generating, based on the fused embedding, the converted acoustic feature using the self-attention-based diffusion model.

Example 32. The method according to Examples 25 to 31, where a process of training the self-attention-based diffusion model includes:
determining a semantic feature of a training audio;
in a first training phase, pre-training an untrained self-attention-based diffusion model based on the training audio and the semantic feature of the training audio;
after the first training phase, generating, based on the training audio and a random audio, a timbre-changed semantic feature using a pre-trained self-attention-based diffusion model, where a timbre of the random audio is different from a timbre of the training audio; and
in a second training phase, training the pre-trained self-attention-based diffusion model based on the training audio and the timbre-changed semantic feature.

Example 33. The method according to Examples 25 to 32, where in the first training phase, pre-training the self-attention-based diffusion model based on the training audio and the semantic feature of the training audio includes:
extracting a partial audio from the training audio;
generating, based on the semantic feature of the training audio and the partial audio, a first predicted acoustic feature using the untrained self-attention-based diffusion model;
determining an acoustic feature of the training audio; and
pre-training the untrained self-attention-based diffusion model by calculating a loss between the first predicted acoustic feature and the acoustic feature of the training audio.

Example 34. The method according to Examples 25 to 33, where after the first training phase, generating, based on the training audio and the random audio, the timbre-changed semantic feature using the pre-trained self-attention-based diffusion model includes:
generating, based on the semantic feature of the training audio and the random audio, a timbre-changed acoustic feature using the pre-trained self-attention-based diffusion model; and
generating the timbre-changed semantic feature based on the timbre-changed acoustic feature.

Example 35. The method according to Examples 25 to 34, where generating the timbre-changed semantic feature based on the timbre-changed acoustic feature includes:
generating a timbre-changed audio based on the timbre-changed acoustic feature; and
generating the timbre-changed semantic feature based on the timbre-changed audio.

Example 36. The method according to Examples 25 to 35, where in the second training phase, training the pre-trained self-attention-based diffusion model based on the training audio and the timbre-changed semantic feature includes:
extracting a partial audio from the training audio;
generating, based on the timbre-changed semantic feature and the partial audio, a second predicted acoustic feature using the pre-trained self-attention-based diffusion model;
determining an acoustic feature of the training audio; and
training the pre-trained self-attention-based diffusion model by calculating a loss between the second predicted acoustic feature and the acoustic feature of the training audio.

Although the present disclosure has been described by adopting a language specific to structural features and/or method logical actions, it should be understood that the subject matter limited in the appended claims is not necessarily limited to the specific features or actions described above. On the contrary, the specific features and the actions described above are merely example forms for implementing the claims.

What is claimed is:

1. A method for timbre conversion, comprising:
determining a semantic feature of an audio to be converted, the audio to be converted having an original timbre;
acquiring a prompt audio, the prompt audio having a target timbre different from the original timbre;
generating, based on the semantic feature of the audio to be converted and the prompt audio, a converted acoustic feature using a self-attention-based diffusion model; and
generating a converted audio based on the converted acoustic feature, the converted audio being an audio in which a timbre of the audio to be converted is converted into the target timbre.

2. The method according to claim 1, wherein the semantic feature of the audio to be converted is an original semantic feature, and generating, based on the semantic feature of the audio to be converted and the prompt audio, the converted acoustic feature using the self-attention-based diffusion model comprises:
determining a text embedding associated with a prompt text of the prompt audio and an original text of the audio to be converted;
determining a semantic embedding associated with a prompt semantic feature of the prompt audio and the original semantic feature of the audio to be converted;
determining a global timbre embedding associated with the prompt audio;
determining a local timbre embedding associated with the prompt audio; and
generating the converted acoustic feature based on the text embedding, the semantic embedding, the global timbre embedding, and the local timbre embedding.

3. The method according to claim 2, wherein determining the text embedding associated with the prompt text of the prompt audio and the original text of the audio to be converted comprises:
generating, based on the prompt text and the original text, the text embedding using a text encoder.

4. The method according to claim 2, wherein determining the semantic embedding associated with the prompt semantic feature of the prompt audio and the original semantic feature of the audio to be converted comprises:
generating, based on the prompt semantic feature and the original semantic feature, the semantic embedding using a semantic encoder.

5. The method according to claim 2, wherein determining the global timbre embedding associated with the prompt audio comprises:
determining a prompt acoustic feature of the prompt audio; and
generating, based on the prompt acoustic feature, the global timbre embedding by using a global timbre encoder and taking the prompt acoustic feature as a whole in a time dimension.

6. The method according to claim 2, wherein determining the local timbre embedding associated with the prompt audio comprises:
determining a prompt acoustic feature of the prompt audio;
splitting the prompt acoustic feature into a plurality of local acoustic features in a time dimension; and
generating, based on the plurality of local acoustic features, the local timbre embedding using a local timbre encoder.

7. The method according to claim 2, wherein generating the converted acoustic feature based on the text embedding, the semantic embedding, and the timbre embedding comprises:
generating a random noise;
generating, based on the random noise, a noised acoustic embedding using a noised acoustic feature encoder;
generating a fused embedding based on the text embedding, the semantic embedding, the global timbre embedding, the local timbre embedding, and the noised acoustic embedding; and
generating, based on the fused embedding, the converted acoustic feature using the self-attention-based diffusion model.

8. The method according to claim 1, wherein a process of training the self-attention-based diffusion model comprises:
determining a semantic feature of a training audio;
in a first training phase, pre-training an untrained self-attention-based diffusion model based on the training audio and the semantic feature of the training audio;
after the first training phase, generating, based on the training audio and a random audio, a timbre-changed semantic feature using the pre-trained self-attention-based diffusion model, wherein a timbre of the random audio is different from a timbre of the training audio; and
in a second training phase, training the pre-trained self-attention-based diffusion model based on the training audio and the timbre-changed semantic feature.

9. The method according to claim 8, wherein in the first training phase, pre-training the self-attention-based diffusion model based on the training audio and the semantic feature of the training audio comprises:
extracting a partial audio from the training audio;
generating, based on the semantic feature of the training audio and the partial audio, a first predicted acoustic feature using the untrained self-attention-based diffusion model;
determining an acoustic feature of the training audio; and
pre-training the untrained self-attention-based diffusion model by calculating a loss between the first predicted acoustic feature and the acoustic feature of the training audio.

10. The method according to claim 8, wherein after the first training phase, generating, based on the training audio and the random audio, the timbre-changed semantic feature using the pre-trained self-attention-based diffusion model comprises:
generating, based on the semantic feature of the training audio and the random audio, a timbre-changed acoustic feature using the pre-trained self-attention-based diffusion model; and
generating the timbre-changed semantic feature based on the timbre-changed acoustic feature.

11. The method according to claim 10, wherein generating the timbre-changed semantic feature based on the timbre-changed acoustic feature comprises:
generating a timbre-changed audio based on the timbre-changed acoustic feature; and
generating the timbre-changed semantic feature based on the timbre-changed audio.

12. The method according to claim 8, wherein in the second training phase, training the pre-trained self-attention-based diffusion model based on the training audio and the timbre-changed semantic feature comprises:
extracting a partial audio from the training audio;
generating, based on the timbre-changed semantic feature and the partial audio, a second predicted acoustic feature using the pre-trained self-attention-based diffusion model;
determining an acoustic feature of the training audio; and
training the pre-trained self-attention-based diffusion model by calculating a loss between the second predicted acoustic feature and the acoustic feature of the training audio.

13. An electronic device, comprising:
a processor; and
a memory coupled with the processor, wherein the memory has instructions stored therein, and the instructions, when executed by the processor, cause the electronic device to:
determine a semantic feature of an audio to be converted, the audio to be converted having an original timbre;
acquire a prompt audio, the prompt audio having a target timbre different from the original timbre;
generate, based on the semantic feature of the audio to be converted and the prompt audio, a converted acoustic feature using a self-attention-based diffusion model; and
generate a converted audio based on the converted acoustic feature, the converted audio being an audio in which a timbre of the audio to be converted is converted into the target timbre.

14. The electronic device according to claim 13, wherein the semantic feature of the audio to be converted is an original semantic feature, and the instructions causing the electronic device to generate, based on the semantic feature of the audio to be converted and the prompt audio, the converted acoustic feature using the self-attention-based diffusion model comprise instructions causing the electronic device to:
determine a text embedding associated with a prompt text of the prompt audio and an original text of the audio to be converted;
determine a semantic embedding associated with a prompt semantic feature of the prompt audio and the original semantic feature of the audio to be converted;
determine a global timbre embedding associated with the prompt audio;
determine a local timbre embedding associated with the prompt audio; and
generate the converted acoustic feature based on the text embedding, the semantic embedding, the global timbre embedding, and the local timbre embedding.

15. The electronic device according to claim 14, wherein the instructions causing the electronic device to determine the text embedding associated with the prompt text of the prompt audio and the original text of the audio to be converted comprise instructions causing the electronic device to:
generate, based on the prompt text and the original text, the text embedding using a text encoder.

16. The electronic device according to claim 14, wherein the instructions causing the electronic device to determine the semantic embedding associated with the prompt semantic feature of the prompt audio and the original semantic feature of the audio to be converted comprise instructions causing the electronic device to:
generate, based on the prompt semantic feature and the original semantic feature, the semantic embedding using a semantic encoder.

17. The electronic device according to claim 14, wherein the instructions causing the electronic device to determine the global timbre embedding associated with the prompt audio comprise instructions causing the electronic device to:
determine a prompt acoustic feature of the prompt audio; and
generate, based on the prompt acoustic feature, the global timbre embedding by using a global timbre encoder and taking the prompt acoustic feature as a whole in a time dimension.

18. The electronic device according to claim 14, wherein the instructions causing the electronic device to determine the local timbre embedding associated with the prompt audio comprise instructions causing the electronic device to:
determine a prompt acoustic feature of the prompt audio;
split the prompt acoustic feature into a plurality of local acoustic features in a time dimension; and
generate, based on the plurality of local acoustic features, the local timbre embedding using a local timbre encoder.

19. The electronic device according to claim 14, wherein the instructions causing the electronic device to generate the converted acoustic feature based on the text embedding, the semantic embedding, and the timbre embedding comprise instructions causing the electronic device to:
generate a random noise;
generate, based on the random noise, a noised acoustic embedding using a noised acoustic feature encoder;
generate a fused embedding based on the text embedding, the semantic embedding, the global timbre embedding, the local timbre embedding, and the noised acoustic embedding; and
generate, based on the fused embedding, the converted acoustic feature using the self-attention-based diffusion model.

20. A computer program product stored on a non-transitory computer readable medium, comprising computer-executable instructions, wherein the computer-executable instructions, when executed by a processor, cause an electronic device to:
determine a semantic feature of an audio to be converted, the audio to be converted having an original timbre;
acquire a prompt audio, the prompt audio having a target timbre different from the original timbre;
generate, based on the semantic feature of the audio to be converted and the prompt audio, a converted acoustic feature using a self-attention-based diffusion model; and
generate a converted audio based on the converted acoustic feature, the converted audio being an audio in which a timbre of the audio to be converted is converted into the target timbre.
